(19) United States
(12) Patent Application Publication
(10) Pub. No.: US 2021/0207672 A1
(43) Pub. Date: Jul. 8, 2021

(54) FRICTION MATERIAL AND FRICTION MATERIAL COMPOSITION

(71) Applicant: ADVICS CO., LTD., Kariya-shi (JP)

(72) Inventors: Takuya UEKI, Tajimi-shi (JP); Chihiro OKAMOTO, Kariya-shi (JP)

(73) Assignee: ADVICS CO., LTD., Kariya-shi (JP)

(21) Appl. No.: 17/056,609

(22) PCT Filed: May 28, 2019
(86) PCT No.: PCT/JP2019/020978

§ 371 Date: Nov. 18, 2020

(30) Foreign Application Priority Data
May 28, 2018 (JP) 2018-101815

(51) Int. Cl. F16D 69/02

(52) U.S. Cl. CPC F16D 69/026; F16D 2200/0069; F16D 2200/0043; F16D 2200/0004

(57) ABSTRACT

A friction material according to an embodiment is a friction material including: copper in an amount of 0.5 wt % or less; an inorganic material having a cleavage property in an amount of 10 wt % to 20 wt %; a first abrasive material having a Mohs hardness of 6.5 or more and less than 7 and a second abrasive material having a Mohs hardness of 7 or more and 8 or less in an amount of 0.2 wt % to 3 wt %.

### TECHNICAL FIELD

The present disclosure relates to a friction material and a friction material on composition.

### BACKGROUND ART

In recent years, there has been concern that material, or copper, contained in brake pads may pollute rivers and oceans and has adverse effects on the human body. It has been necessary to develop brake pads, or friction materials, containing a small amount or less of copper.

### CITATION LIST

### Patent Literature

PTL 1: Japanese Patent Application Publication No. 2014-122314

PTL 2: Japanese Patent No. 6233461

### BRIEF SUMMARY

### Technical Problem

The brake pad (friction material) may have an attacking property too high some counterpart member. The attacking property may depend on an abrasive material contained in the or a counterpart member such as a rotor. If the attacking property is too high, a wear amount of the counterpart member may be too much. In addition, a cleaning action on a friction surface may be lowered. This cause excessive film formation and progression of mirror finish of the friction surface. Subsequently, a friction coefficient maybe increased greatly in a high humidity environment. This may cause squealing, excessive braking force, and a state in which the vehicle abruptly tilts forward and then abruptly returns to its original position.

Then, an object of the disclosure is to provide a friction material and a friction material composition capable of maintaining a desired friction coefficient by, in a friction material that does not contain copper (or has a reduced copper content), providing a moderate abrasive force, and preventing smoothing of a friction surface and a fluctuation in the friction coefficient due to an environmental change and a braking condition.

### Solution to Problem

In order to solve the above problem, a friction material according to an aspect is a friction material including: copper in an amount of 0.5 wt % or less; an inorganic material having a cleavage property in an amount of 10 wt % to 20 wt %; a first abrasive material having a Mohs hardness of 6.5 or more and less than 7; and a second abrasive material having a Mohs hardness of 7 or more and 8 or less in an amount of 0.2 wt % to 3 wt %.

According to the above configuration, a moderate abrasive force can be obtained, smoothing of a friction surface can be prevented, and a fluctuation in a friction coefficient due to an environmental change and a braking condition can be prevented.

In addition, a friction material composition according to an aspect is a friction material composition including: copper in an amount of 0.5 wt % or less; a fibrous base material; a friction modifier; a thermosetting binder; a filler; an inorganic material having a cleavage property in an amount of 10 wt % to 20 wt %; a first abrasive material having a Mohs hardness of 6.5 or more and less than 7; and a second abrasive material having a Mohs hardness of 7 or more and 8 or less in an amount of 0.2 wt % to 3 wt %.

According to the above configuration, it is possible to obtain a friction material in which the moderate abrasive force can be obtained, the smoothing of the friction surface can be prevented, and the fluctuation in the friction coefficient due to the environmental change and the braking condition can be prevented.

### BRIEF DESCRIPTION OF DRAWINGS

FIG. 1 is an external perspective view of a brake pad according to an embodiment.

FIG. 2 is a diagram illustrating a method of manufacturing a brake pad using a friction material according to the embodiment.

FIG. 3 is a diagram illustrating performance evaluation results for Examples and Comparative Examples.

### DESCRIPTION OF EMBODIMENTS

Next, an exemplary embodiment of the disclosure will be described in detail with reference to the drawings.

A configuration of the embodiment shown below and actions and results (effects) provided by the configuration are exemplary. The disclosure can be implemented by a configuration other than the configuration disclosed in the following embodiment. According to the disclosure, at least one of various effects (including derived effects) obtained by the configuration can be obtained.

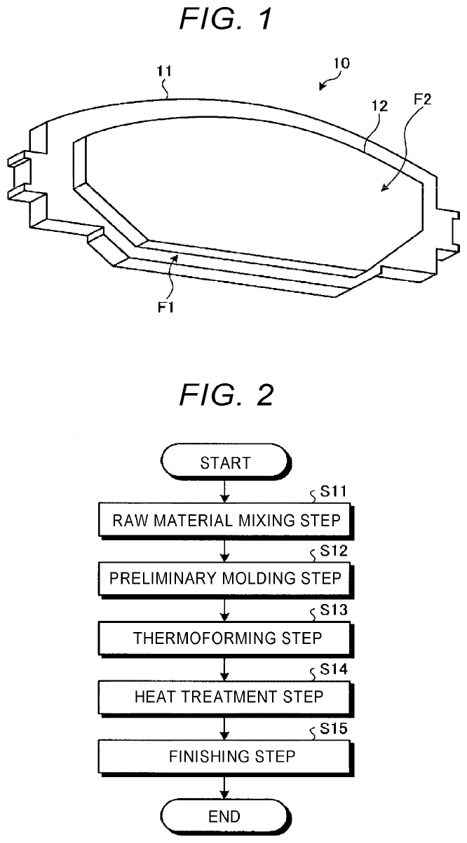

FIG. 1 is an external perspective view of a brake pad according to an embodiment.

A brake pad 20 includes a back plate 21 having a first surface F1 and a lining 22 in contact with the first surface F1 and having a second surface F2 that is located on a side opposite to the first surface F1 with respect to a center in a thickness direction and that is substantially parallel to the first surface F1.

First, a principle of the embodiment will be described.

When a friction material containing copper in an amount of 0.5 wt % or less is formed to reduce an environmental load, a friction coefficient at a low temperature is lowered (deteriorates).

In order to avoid this, it is known that, by adding mica as an inorganic material having a cleavage property and combining 3 wt % or less of an abrasive material, a moderate friction coefficient μ can be obtained, and an attacking property to a counterpart member such as a rotor is prevented to prevent occurrence of a thickness difference.

However, since an amount of copper and an amount of the abrasive material are small, a friction surface maybe smoothed, and a friction coefficient maybe excessively increased at high humidity.

In addition, due to an insufficient abrasive force, the friction coefficient μ at a high speed and a high pressure may be lowered and a rust removal property for the counterpart member may be lowered.

In order to avoid this, the present embodiment provides a friction material containing copper in an amount of 0.5 wt % or less. The friction material contains: an inorganic material having a cleavage property in an amount of 10 wt % to 20 wt %; a first abrasive material having a Mohs hardness of 6.5 or more and less than 7; and a second abrasive material having a Mohs hardness of 7 or more and 8 or less in an amount of 0.2 wt % to 3 wt %.

According to the configuration, the rust of the counterpart member such as a rotor can be removed and a desired friction coefficient μ can be obtained by the first abrasive material. In addition, with the second abrasive material, a desired abrasive force can be obtained, the smoothing of the friction surface can be prevented, and the friction coefficient μ influenced by an environmental change and a braking condition can be stabilized.

In this case, if the second abrasive material contains a plurality of types of abrasive materials, a stable abrasive force can be obtained under various usage conditions.

Further, by setting an average particle diameter of the second abrasive material to be less than 10 μm (more preferably 1 μm to 3 μm), an optimum abrasive force can be obtained while preventing an excessive attacking property to the counterpart member such as a rotor.

In addition, by setting the amount of the first abrasive material to be 0.2 wt % to 1 wt %, a moderate friction coefficient μ can be obtained.

Further, by setting an average particle diameter of the first abrasive material to be 10 μm or more, the rust of the counterpart member such as a rotor can be reliably removed and an optimum friction coefficient μ can be maintained.

That is, according to the present embodiment, while maintaining a state where the optimum friction coefficient μ can be obtained on the friction surface, a desired abrasive force can be obtained, the smoothing of the friction surface can be prevented, and the friction coefficient μ influenced by the environmental change and the braking condition can be stabilized.

Next, a method of manufacturing a brake pad including a specific friction material (lining) will be described.

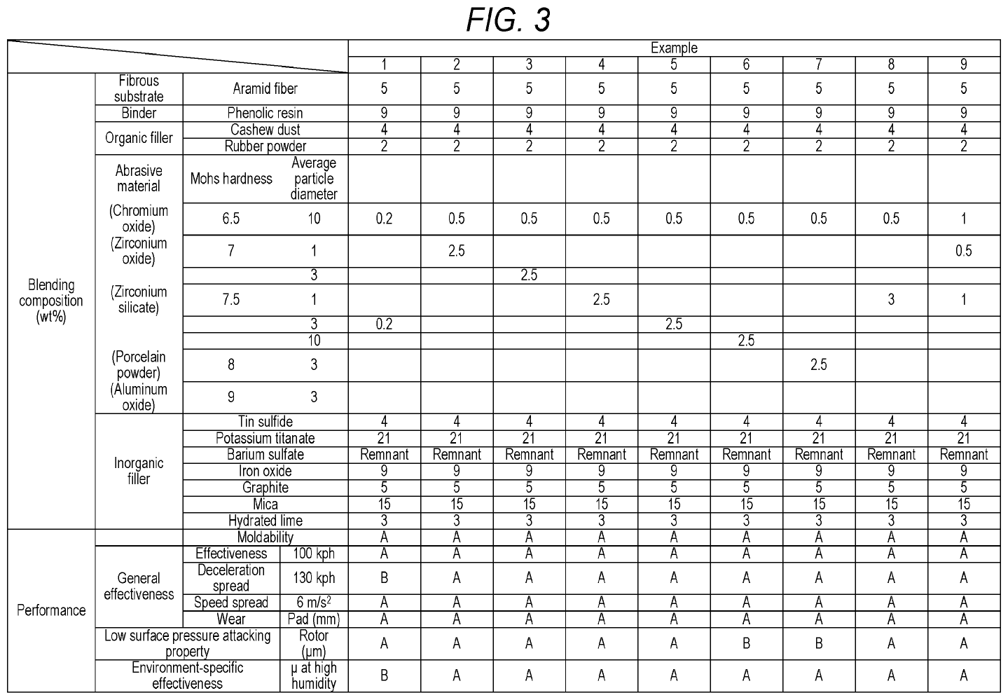

FIG. 2 is a diagram illustrating processing of the method of manufacturing a brake pad using the friction material according to the embodiment.

Predetermined raw materials are mixed to obtain a mixed powder (a friction material composition) (step S11).

Here, the predetermined raw materials refer to a fibrous base material, a binder, an organic filler, an abrasive material, an inorganic filler containing an inorganic material having a cleavage property, and the like.

In this case, examples of the fibrous base material include an aramid fiber and an inorganic fiber.

Examples of the binder include a phenol resin which is a thermosetting resin.

Examples of the organic filler (organic friction modifier) include a cashew dust and a rubber powder (SBR).

Examples of the abrasive material include chromium oxide having a Mohs hardness of 6.5 (corresponding to the first abrasive material), zirconium oxide having a Mohs hardness of 7 (corresponding to the second abrasive material), zirconium silicate having a Mohs hardness of 7.5 (corresponding to the second abrasive material), zirconium boride having a Mohs hardness of 8 (corresponding to the second abrasive material), and a porcelain powder having a Mohs hardness of 8 (corresponding to the second abrasive material).

In the above-mentioned abrasive materials, the first abrasive material has a braking function of removing the rust from a rotor surface on which the brake pad abuts and obtaining a predetermined friction coefficient μ.

On the other hand, the second abrasive material has a function of scraping off the rotor surface by the abrasive force, preventing the smoothing of the rotor, and stabilizing the friction coefficient μ.

Examples of the inorganic filler include barium sulfate, mica which is an inorganic material functioning as a lubricant and having a cleavage property, graphite, and hydrated lime (calcium hydroxide) functioning as a pH adjuster.

Further, examples of the inorganic filler include tin sulfide functioning as an inorganic friction modifier, potassium titanate, and iron oxide.

After the predetermined raw materials are sufficiently mixed, preliminary molding is performed in a preliminary molding step (step S12).

In this preliminary molding, molding is performed to such an extent that a friction material mixture can be placed on a predetermined back plate.

Subsequently, a preliminary molded lining 22 is set in a pressurization and heating mold of a thermoforming device with the preliminary molded lining 22 placed at a predetermined position on a back plate 21, and thermoforming is performed in a first temperature zone (lower than 200° C.) (step S13).

The thermoforming is performed to cure the binder added as a raw material after the binder is fully melted and to maintain a shape of the lining (or the brake pad) in a heat treatment performed at a later stage, and the predetermined raw materials are charged into the mold and are pressurized and heated while the back plate 21 is arranged in the predetermined mold.

In this state, a brake pad 20 including the back plate 21 and the lining 22 is heated in a second temperature zone (200° C. to 240° C.) higher than the first temperature zone for a predetermined time (for example, 1 hour to 2 hours)) while being pressurized to prevent deformation, and the heat treatment for curing the lining 22 is performed (step S14).

Subsequently, the brake pad 20 after the heat treatment is subjected to a predetermined finishing (step S15) to become a product.

According to the present embodiment, since the brake pad 20 contains: the inorganic material having a cleavage property in an amount of 10 wt % to 20 wt %; the first abrasive material having a Mohs hardness of 6.5 or more and less than 7; and the second abrasive material having a Mohs hardness of 7 or more and 8 or less in an amount of 0.2 wt % to 3 wt %, the smoothing of the friction material and the counterpart member (for example, a rotor) can be prevented, a fluctuation in the friction coefficient μ due to the environmental change and the braking condition can be prevented, and stability of the friction coefficient μ can be increased.

### EXAMPLES

Next, examples will be described in detail.

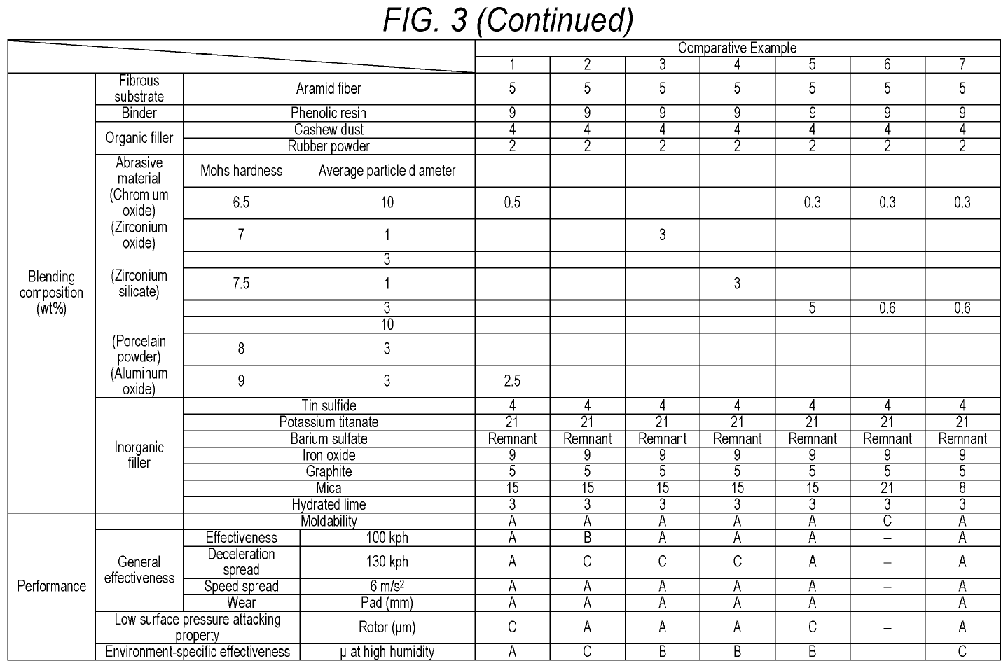

FIG. 3 is a diagram illustrating Examples, Comparative Examples, and performance evaluation therefor.

### [1] Examples

### [1.1] First Example

First, a blending composition of a first example (represented as Example 1 in FIG. 3, the same applies hereinafter) will be described.

Examples of the blending composition of the example roughly include a fibrous base material, a binder, an organic filler, an abrasive material, and an inorganic filler.

Hereinafter, the blending composition of the first example will be described in detail.

In the first example, 5 wt % of an aramid fiber was blended as the fibrous base material.

In the first example, 9 wt % of a phenol resin was blended as the binder.

In the first example, 4 wt % of a cashew dust and 2 wt % of a rubber powder (SBR) were blended as the organic filler.

In the first example, 0.2 wt % of chromium oxide (average particle diameter 10 μm) having a Mohs hardness of 6.5 was blended as the first abrasive material, and 0.2 wt % of zirconium silicate (average particle diameter 3 μm) having a Mohs hardness of 7.5 was blended as the second abrasive material.

In the first example, 4 wt % of tin sulfide, 21 wt % of potassium titanate, 9 wt % of iron oxide, 5 wt % of graphite, 15 wt % of mica, and 3 wt % of hydrated lime were blended as the inorganic filler, and barium sulfate was blended as a remnant to make a total amount of 100 wt %.

### [1.2] Second Example

A blending composition of a second example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of zirconium oxide (average particle diameter 1 μm) having a Mohs hardness of 7 was blended as the second abrasive material.

Other blending compositions are the same as those of the first example.

### [1.3] Third Example

A blending composition of a third example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of zirconium oxide (average particle diameter 3 μm) having a Mohs hardness of 7 was blended as the second abrasive material.

Other blending compositions are the same as those of the first example.

### [1.4] Fourth Example

A blending composition of a fourth example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of zirconium silicate (average particle diameter 1 μm) having a Mohs hardness of 7.5 was blended as the second abrasive material.

Other blending compositions are the same as those of the first example.

### [1.5] Fifth Example

A blending composition of a fifth example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of zirconium silicate (average particle diameter 3 μm) having a Mohs hardness of 7.5 was blended as the second abrasive material.

Other blending compositions are the same as those of the first example.

### [1.6] Sixth Example

A blending composition of a sixth example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of zirconium silicate (average particle diameter 10 μm) having a Mohs hardness of 7.5 was blended as the second abrasive material.

Other blending compositions are the same as those of the first example.

### [1.7] Seventh Example

A blending composition of a seventh example was different from the blending composition of the first example in that 0.5 wt % of chromium oxide (average particle diameter 10 μm) having a Mohs hardness of 6.5 was blended as the first abrasive material, and 2.5 wt % of porcelain powder (average particle diameter 3 μm) having a Mohs hardness of 8 was blended as the second abrasive material.

Other blending compositions are the same as those of the first example.

### [1.8] Eighth Example

A blending composition of an eighth example was different from the blending composition of the first example in that 0.5 wt % of chromium oxide (average particle diameter 10 μm) having a Mohs hardness of 6.5 was blended as the first abrasive material, and 3 wt % of zirconium silicate (average particle diameter 1 μm) having a Mohs hardness of 7.5 was blended as the second abrasive material.

Other blending compositions are the same as those of the first example.

### [1.9] Ninth Example

A blending composition of a ninth example was different from the blending composition of the first example in that 1 wt % of chromium oxide (average particle diameter 10 μm) having a Mohs hardness of 6.5 was blended as the first abrasive material, 0.5 wt % of zirconium silicate (average particle diameter 1 μm) having a Mohs hardness of 7 was blended as the second abrasive material, and 1 wt % of zirconium silicate (average particle diameter 1 μm) having a Mohs hardness of 7.5 was blended as the second abrasive material. That is, the ninth example is an example in which two types (plurality) of second abrasive materials are blended.

Other blending compositions are the same as those of the first example.

### [2] Comparative Examples

Next, comparative examples will be described.

Similar to the blending composition of the example, examples of a blending composition of a comparative example roughly include a fibrous base material, a binder, an organic filler, an abrasive material, and an inorganic filler.

### [2.1] First Comparative Example

First, a blending composition of a first comparative example (expressed as Comparative Example 1 in FIG. 3, the same applies hereinafter) will be described.

The blending composition of the first comparative example was different from the blending composition of the first example in that, regarding blending of the abrasive material, 0.5 wt % of chromium oxide (average particle diameter 10 μm) having a Mohs hardness of 6.5 was blended as the first abrasive material, and 2.5 wt % of aluminum oxide (average particle diameter 3 μm) having a Mohs hardness of 9 was blended as another abrasive material.

Other blending compositions are the same as those of the first example.

### [2.2] Second Comparative Example

A blending composition of a second comparative example was different from the blending composition of the first example in that no abrasive material was blended.

Other blending compositions are the same as those of the first example.

### [2.3] Third Comparative Example

A blending composition of a third comparative example was different from the blending composition of the first example in that, regarding blending of the abrasive material, 3 wt % of zirconium oxide (average particle diameter 1 μm) having a Mohs hardness of 7 was blended.

Other blending compositions are the same as those of the first example.

### [2.4] Fourth Comparative Example

A blending composition of a fourth comparative example was different from the blending composition of the first example in that, regarding blending of the abrasive material, 3 wt % of zirconium silicate (average particle diameter 1 μm) having a Mohs hardness of 7.5 was blended.

Other blending compositions are the same as those of the first example.

### [2.5] Fifth Comparative Example

A blending composition of a fifth comparative example was different from the blending composition of the first example in that, regarding blending of the abrasive material, 0.3 wt % of chromium oxide (average particle diameter 10 μm) having a Mohs hardness of 6.5 and 5 wt % of zirconium silicate (average particle diameter 3 μm) having a Mohs hardness of 7.5 were blended.

Other blending compositions are the same as those of the first example.

### [2.6] Sixth Comparative Example

A blending composition of a sixth comparative example was different from the blending composition of the first example in that, regarding blending of the abrasive material, 0.3 wt % of chromium oxide (average particle diameter 10 μm) having a Mohs hardness of 6.5 and 0.6 wt % of zirconium silicate (average particle diameter 3 μm) having a Mohs hardness of 7.5 were blended, and regarding blending of the inorganic filler, 21 wt % of mica was blended.

Other blending compositions are the same as those of the first example.

### [2.7] Seventh Comparative Example

A blending composition of a seventh comparative example was different from the blending composition of the first example in that, regarding blending of the abrasive material, 0.3 wt % of chromium oxide (average particle diameter 10 μm) having a Mohs hardness of 6.5 and 0.6 wt % of zirconium silicate (average particle diameter 3 μm) having a Mohs hardness of 7.5 were blended, and regarding blending of the inorganic filler, 8 wt % of mica was blended.

Other blending compositions are the same as those of the first example.

### [3] Characteristic and Performance Evaluation

Next, performance evaluation results of each of the above Examples and each of the above Comparative Examples will be described with reference to FIG. 3 again.

As performance evaluation, moldability, general effectiveness, a low surface pressure attacking property, and environment-specific effectiveness were evaluated.

### [3.1] Moldability

A brake pad was actually molded and evaluated for the possibility of practical molding.

Specifically, in FIG. 3, a case where the molding was possible was determined as A (excellent), and a case where the molding was not possible was determined as C (poor).

### [3.2] General Effectiveness

As evaluation items of general effectiveness, effectiveness, deceleration spread, speed spread, and a wear amount were evaluated.

### [3.2.1] Effectiveness

Effectiveness was measured according to JASO C406 using a brake assembly (caliper, brake pad, rotor) for a passenger vehicle.

Specifically, the friction coefficient a at second effectiveness (initial speed=50 km/h, initial speed=100 km/h, braking deceleration G=6.0 m/s²) was determined.

In FIG. 3, a case where the friction coefficient μ was 0.35 to 0.45 was determined as (excellent), a case where the friction coefficient μ was 0.30 to 0.35 or the friction coefficient μ was 0.45 to 0.50 was determined as B (good), and a case where the friction coefficient μ was less than 0.30 or the friction coefficient μ was more than 0.50 was determined as C (poor).

### [3.2.2] Deceleration Spread

The deceleration spread was measured according to JASO C406 using a brake assembly (caliper, brake pad, rotor) for a passenger vehicle.

Specifically, a difference between a maximum value and a minimum value in each friction coefficient μ at the second effectiveness (braking deceleration G=1 m/s² to 10 m/s² at an initial speed of 100 km/h) was determined.

In FIG. 3, a case where the difference was less than 0.06 was determined as A (excellent), a case where the difference was 0.06 to 0.12 was determined as B (good), and a case where the difference was more than 0.12 was determined as C (poor).

[3.2.3] Speed spread

The speed spread was measured according to JASO C406 using a brake assembly (caliper, brake pad, rotor) for a passenger vehicle.

Specifically, a difference between a maximum value and a minimum value in each friction coefficient μ at the second effectiveness (braking deceleration G=6.0 m/s² at an initial speed of 50 km/h to 130 km/h) was determined.

In FIG. 3, a case where the difference was less than 0.06 was determined as A(excellent), a case where the difference was 0.06 to 0.12 was determined as B (good), and a case where the difference was more than 0.12 was determined as C (poor).

### [3.2.4] Wear

The wear amount of the brake pad (difference in brake pad thickness before and after a test) was measured according to JASO C406 using a brake assembly (caliper, brake pad, rotor) for a passenger vehicle.

Specifically, a wear amount of the brake pad of less than 1 mm was determined as A (excellent), 1 mm to 1.5 mm as B (good), and more than 1.5 mm as C (poor).

### [3.3] Low Surface Pressure Attacking Property

A rotor wear amount (difference in rotor thickness before and after a test) was measured when a 25 mm×25 mm friction material (pad) was used as a test sample, the material of the rotor was FC250, the test sample was rotated at a speed of 100 km/h for 24 hours while being pressed against the rotor at a surface pressure of 0.05 MPa as a test condition.

Specifically, a wear amount of the rotor of less than 10 μm was evaluated as A (excellent), 10 μm to 20 μm as B (good), and more than 20 μm as C (poor).

### [3.4] Environment-Specific Effectiveness

The friction coefficient μ was measured using a brake assembly (caliper, brake pad, rotor) for a passenger car while changing an environment between a temperature of −10° C. to 30° C. and a humidity of 30% to 90%.

Specifically, in FIG. 3, a case where a maximum value of the friction coefficient μ during the test was less than 0.6 was evaluated as A (excellent), a case where the maximum value of the friction coefficient μ during the test was 0.60 to 0.65 was evaluated as B (good), and a case where the maximum value of the friction coefficient μ during the test was more than 0.65 was evaluated as C (poor).

### [3.5] Overall Evaluation Result

As shown in FIG. 3, regarding items of the deceleration spread and the environment-specific effectiveness in the first example and items of the low surface pressure attacking property in the sixth example and the seventh example, there is no problem in practical use, and good results were obtained in each example excluding these examples.

In contrast, it is found that the sixth comparative example has a problem in moldability, and in the first to seventh comparative examples excluding the sixth comparative example, practical problems may occur in any one of the deceleration spread, the low surface pressure attacking property, and the environment-specific effectiveness.

From the results of the comparative examples, it is found that, in order to prevent the effect of the low surface pressure attacking property and the change in the braking condition, it is effective to contain both the first abrasive material having a Mohs hardness of 6.5 or more and less than 7 and the second abrasive material having a Mohs hardness of 7 or more and 8 or less in the friction material containing copper in the amount of 0.5 wt % or less.

In this case, it is considered that, in order to prevent the fluctuation in the friction coefficient, the amount of the first abrasive material having a Mohs hardness of 6.5 or more and less than 7 is preferably 0.2 wt % to 1 wt %, and from the results of items of the deceleration spread and the environment-specific effectiveness in the first example, the amount of the first abrasive material having a Mohs hardness of 6.5 or more and less than 7 is preferably 0.5 wt % to 1 wt %.

Further, it is considered that, in order to lower the low surface pressure attacking property, from the results of the sixth example and the seventh example, the Mohs hardness of the second abrasive material that exerts the abrasive force is preferably 7 or more and 8 or less, and the average particle diameter thereof is preferably less than 10 μm, and more preferably 1 μm to 3 μm.

### [4] Modification of Embodiment

In the above description, only one type of the first abrasive material is described, but it is also possible to mix a plurality of types of abrasive materials similarly to the second abrasive material.

By adopting such a configuration, it is possible to maintain the friction coefficient more stably even when the environmental condition, the braking condition, and the like change.

In the above description, a floating type disc brake is described as an example, but the disclosure can be similarly applied to a so-called opposed type (opposite piston type) disc brake in which pistons as pressing members are arranged opposite to each other, and the pistons arranged opposite press a pair of pad assemblies for brake pad against a disc rotor (friction-applied member).

In the above description, the brake pad (lining) for disc brake is described, but the disclosure can be similarly applied to a brake shoe of a drum brake to be in contact with a brake drum (friction-applied member).

1. A friction material comprising:
copper in an amount of 0.5 wt % or less;
an inorganic material having a cleavage property in an amount of 10 wt % to 20 wt %;
a first abrasive material having a Mohs hardness of 6.5 or more and less than 7; and
a second abrasive material having a Mohs hardness of 7 or more and 8 or less in an amount of 0.2 wt % to 3 wt %.

2. The friction material according to claim 1, wherein
the second abrasive material includes a plurality of types of abrasive materials.

3. The friction material according to claim 1, wherein an average particle diameter of the second abrasive material is less than 10 μm.

4. The friction material according to claim 3, wherein
the average particle diameter of the second abrasive material is 1 μm to 3 μm.

5. The friction material according to claim 1, wherein
an amount of the first abrasive material is 0.2 wt % to 1 wt %.

6. The friction material according to claim 1, wherein
an average particle diameter of the first abrasive material is 10 μm or more.

7. A friction material composition comprising:
copper in an amount of 0.5 wt % or less;
a fibrous base material;
a friction modifier;
a thermosetting binder;
a filler;
an inorganic material having a cleavage property in an amount of 10 wt % to 20 wt %;
a first abrasive material having a Mohs hardness of 6.5 or more and less than 7; and
a second abrasive material having a Mohs hardness of 7 or more and 8 or less in an amount of 0.2 wt % to 3 wt %.

8. The friction material according to claim 2, wherein
an average particle diameter of the second abrasive material is less than 10 μm.

9. The friction material according to claim 2, wherein
an amount of the first abrasive material is 0.2 wt % to 1 wt %.

10. The friction material according to claim 2, wherein
an average particle diameter of the first abrasive material is 10 μm or more.

11. The friction material according to claim 3, wherein
an amount of the first abrasive material is 0.2 wt % to 1 wt %.

12. The friction material according to claim 3, wherein
an average particle diameter of the first abrasive material is 10 μm or more.

13. The friction material according to claim 4, wherein
an amount of the first abrasive material is 0.2 wt % to 1 wt %.

14. The friction material according to claim 4, wherein
an average particle diameter of the first abrasive material is 10 μm or more.

15. The friction material according to claim 5, wherein an average particle diameter of the first abrasive material is 10 μm or more.
